(19) United States
(12) Patent Application Publication
(10) Pub. No.: US 2026/0194167 A1
(43) Pub. Date: Jul. 9, 2026

(54) FRACTURING HOSE FOR HIGH-PRESSURE OILFIELD

(71) Applicant: Techfluid Yantai Limited, Yantai (CN)

(72) Inventors: Jincheng XU, Yantai (CN); Peng YANG, Yantai (CN); Xu GUO, Yantai (CN)

(73) Assignee: Techfluid Yantai Limited, Yantai (CN)

(21) Appl. No.: 19/412,914

(22) Filed: Dec. 9, 2025

(30) Foreign Application Priority Data
Jan. 3, 2025 (CN) 2025100086301

(51) Int. Cl. F16L 23/028

(52) U.S. Cl. CPC F16L 23/0286

(57) ABSTRACT

A fracturing hose for a high-pressure oilfield includes: a hose and a connector disposed at an end of the hose, where an outer wall of the connector is provided with a limit groove and a flange; a limit assembly is disposed in the limit groove; the flange is sleeved outside the connector; and the limit assembly is configured to limit a position of the flange. The limit assembly can replace the limit screw used in the prior art. Without the limit screw, the limit assembly can also be mounted conveniently, and axially limit the position of the flange, thereby effectively preventing the situation that the limit screw is cut off by the flange in the prior art. When the flange moves relative to the connector and the limit assembly falls off the flange, the limit assembly can still remain as a whole on the limit groove.

### CROSS REFERENCE TO THE RELATED APPLICATIONS

This application is based upon and claims priority to Chinese Patent Application No. 202510008630.1, filed on January 3, 2025, the entire contents of which are incorporated herein by reference.

### TECHNICAL FIELD

The present disclosure relates to the technical field of fracturing hoses, and in particular to a fracturing hose for a high-pressure oilfield.

### BACKGROUND

For oilfield fracturing hoses, due to harsh working conditions, high vibrations, high pressures, as well as large flow rates and high velocities of the internal medium, welding a steel pipe to an end connector of the hose will lead to stress cracking. Hence, the end of the hose is typically connected using a flange and a screw. After the flange passes through the hose, a split collar and a limit screw are usually disposed on the connector to limit an axial position of the flange, as shown in FIG. 1. To limit the flange axially, this prior art is also employed in the patent CN202410327290.

However, this implementation has significant problems and potential safety hazards in use. For example, the limit screw located at the rear of the flange will be cut off by the flange, with a cut end flattened. After the screw is cut off, the flange moves backward, and the internal split collar falls off, causing injury to people. Moreover, the flattened and deformed cut end makes the screw impossible to remove, which prevents subsequent maintenance. When the prior art is used on site by the Western Drilling of China National Petroleum Corporation (CNPC), the screw at the rear of the flange is cut off, the flange moves, the internal split collar falls off completely, and the screw is stuck and cannot be removed because the cut end is flattened by the flange. In view of this, how to eliminate the limit screw and still ensure that the split collar does not fall off after the limit screw is eliminated is a technical problem to be solved by the present disclosure.

### SUMMARY

The "Summary" section introduces a series of simplified concepts, which will be further elaborated in the "Detailed Description of the Embodiments" section. The "Summary" section of the present disclosure is not intended to limit the key and necessary technical features of the claimed technical solution or define the scope of protection of the claimed technical solution.

To at least partially solve the above-mentioned problems, the present disclosure provides a fracturing hose for a high-pressure oilfield, including: a hose and a connector disposed at an end of the hose, where the connector is a tubular structure with an outer diameter of r; an outer wall of the connector is provided with a limit groove and a flange; a limit assembly is disposed in the limit groove; the flange is sleeved outside the connector; and the limit assembly is configured to limit a position of the flange.

Preferably, the limit assembly includes at least two arc-shaped limit members and a connecting piece; the limit members are located in the limit groove; two adjacent limit members are connected via the connecting piece; and the limit members are configured to limit the position of the flange.

Preferably, a central hole of the flange includes a first hole with an inner diameter of R and a second hole with an inner diameter of Rf, where the first hole communicates with the second hole, and Rf>R, R≥r; and a junction between the first hole and the second hole forms a first end surface abutting against the limit members.

Preferably, each of the limit members includes an abutment end surface abutting against an inner bottom wall of the limit groove, a second end surface abutting against the first end surface, a third end surface and a fourth end surface that respectively abut against two inner sidewalls of the limit groove, and a fifth end surface connected to the connecting piece; the third end surface and the fourth end surface are respectively located at two sides of the abutment end surface; the third end surface is connected to the second end surface; the fourth end surface is connected to the fifth end surface; and the fifth end surface is located between an inner wall of the second hole and the outer wall of the connector.

Preferably, the connecting piece includes an annular first connecting piece; the first connecting piece is axially provided with at least two first through holes; at least one threaded hole is formed in the fifth end surface of each of the limit members; a quantity and positions of first through holes are matched with a quantity and positions of threaded holes; and the first connecting piece is connected to the fifth end surface through screws.

Preferably, an end surface of the first connecting piece away from the fifth end surface is axially provided with a plurality of placement grooves; and the screws are respectively located in the plurality of placement grooves.

Preferably, the connecting piece includes a plurality of arc-shaped second connecting pieces; the second connecting pieces are matched with the limit members in quantity; at least two threaded holes are formed in the fifth end surface of each of the limit members; the threaded holes are respectively located at two ends of the limit member; each of the second connecting pieces is axially provided with at least two second through holes; the second connecting piece is connected to the at least two threaded holes through screws; and two adjacent limit members are connected via the second connecting piece.

Preferably, the connecting piece includes a third connecting piece; the third connecting piece is removably connected to the inner wall of the second hole; and the fifth end surface selectively abuts against an end of the third connecting piece.

Preferably, the inner wall of the second hole is provided with an internal thread; the third connecting piece is an annular structure with an external thread; and an outer wall of the third connecting piece is threadedly connected to the inner wall of the second hole.

Preferably, an outer sidewall of the flange is provided with a third through hole communicated with the second hole; and an opening of the third through hole adjacent to the outer sidewall of the flange is provided with a nozzle.

Compared with the prior art, the present disclosure has at least the following beneficial effects.

The removable limit assembly can replace the limit screw used in the prior art and in the patent CN202410327290. Without the limit screw, the limit assembly can also be mounted conveniently, and axially limit the position of the flange, thereby effectively preventing the situation that the limit screw is cut off by the flange. When the flange moves relative to the connector (typically, the flange moves backward) and the limit assembly falls off the flange, the limit assembly can still remain as a whole on the limit groove, and does not fall off the connector to cause injury to people.

Other advantages, objects, and features of the fracturing hose for a high-pressure oilfield provided by the present disclosure will be partially embodied through the following description, and some will be understood by those skilled in the art through the research and practice for the present disclosure.

### BRIEF DESCRIPTION OF THE DRAWINGS

The drawings are provided for further understanding of the present disclosure and constitute a part of the specification. The drawings, together with the embodiments of the present disclosure, are intended to explain the present disclosure, rather than to limit the present disclosure. In the accompanying drawings:

FIG. 1 is an exploded view of a defective fracturing hose in the prior art;

FIG. 2 is a schematic diagram of a first implementation of a connecting piece;

FIG. 3 is a sectional view of a first implementation of a connecting piece;

FIG. 4 is an enlarged view of A shown in FIG. 3;

FIG. 5 is a schematic diagram of a second implementation of a connecting piece;

FIG. 6 is an exploded view of a second implementation of a connecting piece;

FIG. 7 is an exploded view of a third implementation of a connecting piece;

FIG. 8 is a sectional view of the exploded view shown in FIG. 7;

FIG. 9A is a sectional view of the prior art, and FIGS. 9B-9D are sectional views of three implementations of the present disclosure; and

FIG. 10 is a schematic diagram of a nozzle on a flange.

In the figures: 100: split collar, 200: limit screw, 1: connector, 2: limit groove, 3: flange, 4: limit member, 5: first end surface, 6: abutment end surface, 7: second end surface, 8: third end surface, 9: fourth end surface, 10: fifth end surface, 11: first connecting piece, 12: second connecting piece, 13: third connecting piece, and 14: nozzle.

### DETAILED DESCRIPTION OF THE EMBODIMENTS

The present disclosure will be further described in detail below with reference to the drawings and embodiments, such that those skilled in the art can implement the present disclosure with reference to the description.

It should be understood that the terms, such as "have", "include", and "comprise" used herein, do not exclude the presence or addition of one or more other elements or a combination thereof.

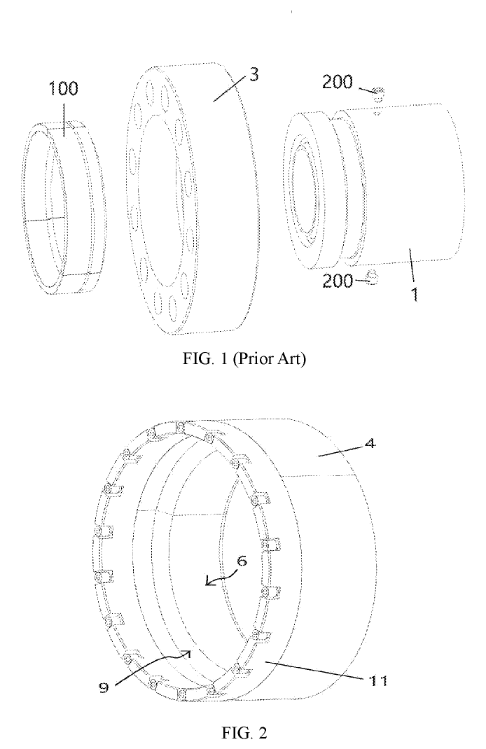

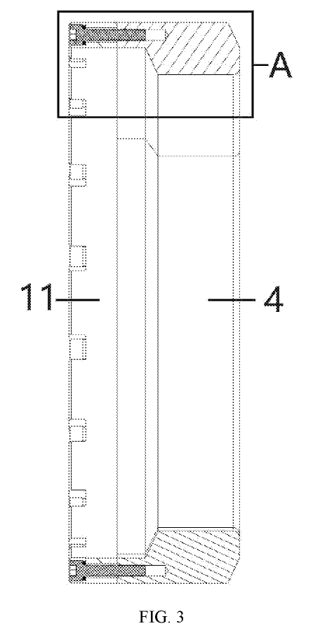

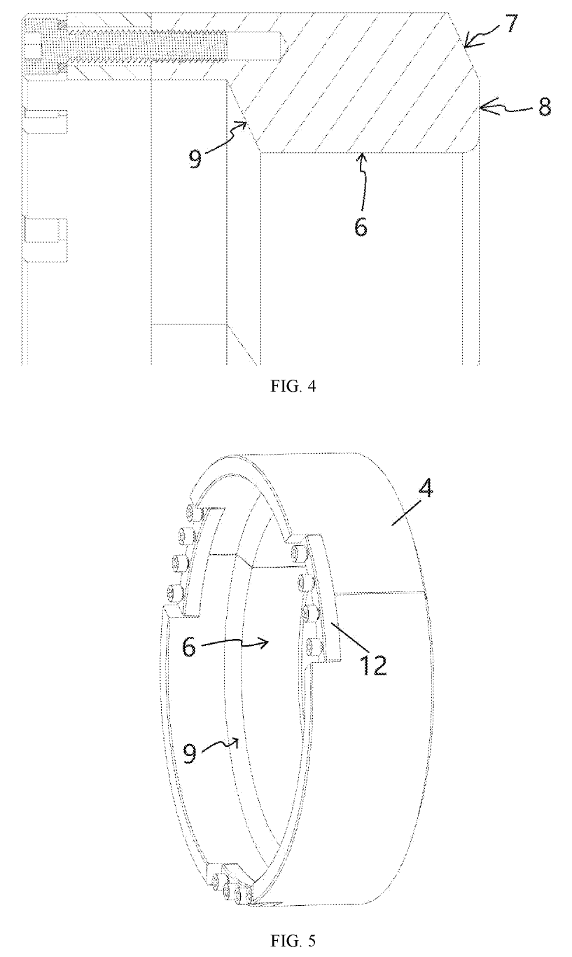

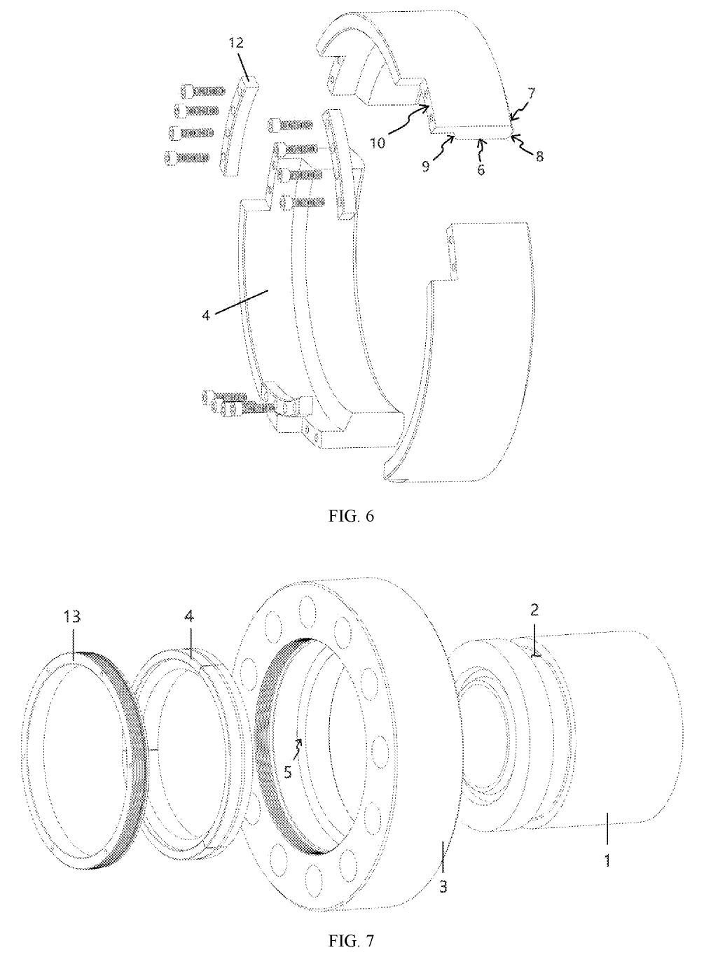

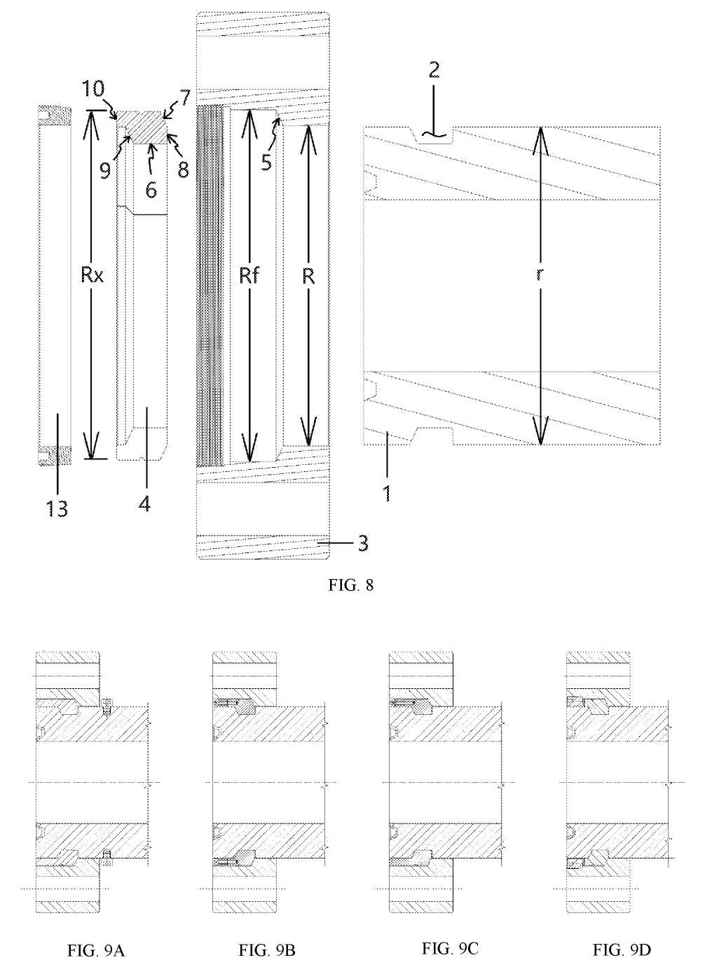

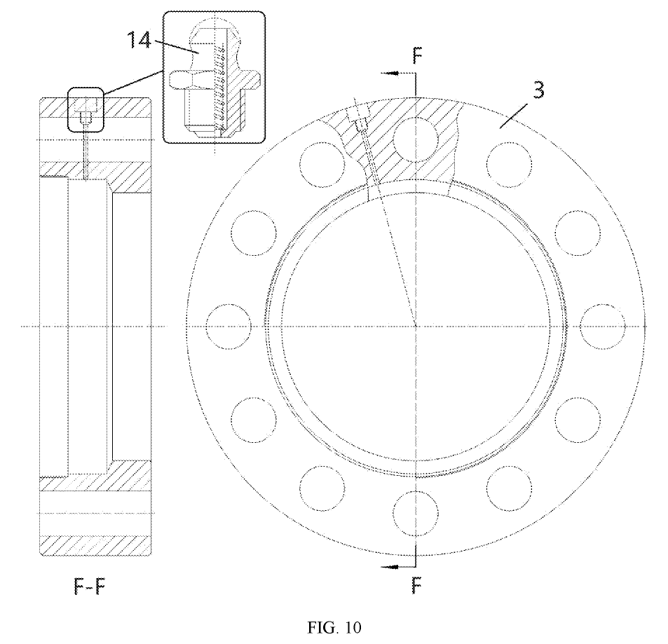

As shown in FIGS. 1-9D, the present disclosure provides a fracturing hose for a high-pressure oilfield, including: a hose and connector 1 disposed at an end of the hose. The connector 1 is a tubular structure with an outer diameter of r. An outer wall of the connector 1 is provided with limit groove 2 and flange 3. As shown in FIG. 7, the limit groove 2 is formed along a circumferential direction of the outer wall of the connector 1, forming an annular groove sleeved on the outer wall of the connector 1. A limit assembly is disposed in the limit groove 2. The limit assembly is a removable split structure. The limit assembly is in the shape of a ring with an outer diameter of Rx as a whole. During mounting, the flange 3 is sleeved on the connector 1, and the limit groove 2 is located in front of the flange 3 (close to an open end of the connector 1). Then, the limit assembly is assembled onto the limit groove 2, and the limit assembly is mounted on the limit groove 2 as a whole. The flange 3 is moved toward an opening of the connector 1, such that the flange 3 is sleeved outside the connector 1 and the limit assembly. The limit assembly is configured to axially limit a position of the flange 3. The removable limit assembly can replace the limit screw used in the prior art and in the patent CN202410327290. Without the limit screw, the limit assembly can also be mounted conveniently, and axially limit the position of the flange 3, thereby effectively preventing the situation that the limit screw is cut off by the flange 3. When the flange 3 moves relative to the connector 1 (typically, the flange 3 moves backward) and the limit assembly falls off the flange 3, the limit assembly can still remain as a whole on the limit groove 2, and does not fall off the connector 1 to cause injury to people. The limit assembly includes at least two arc-shaped limit members 4 and a connecting piece. The limit members 4 are located in the limit groove 2. Two adjacent limit members 4 are connected via the connecting piece. The limit members 4 may be connected end to end to form a limiting ring with an outer diameter of Rx. Since the limit members 4 in the present disclosure are connected via the connecting piece, compared with the prior art in which the limit members 4 are limited by the flange 3, and must be connected end to end to form a closed ring, adjacent limit members 4 in the present disclosure may also not be connected end to end, and according to different usage scenarios and use requirements, a gap is formed between two adjacent limit members 4. The limit members 4 are configured to limit the position of the flange 3. A central hole of the flange 3 includes a first hole with an inner diameter of R and a second hole with an inner diameter of Rf. The first hole and the second hole are coaxial and communicate with each other, Rf≥Rx>R≥r. A junction between the first hole and the second hole forms first end surface 5 abutting against the limit members 4, as shown in FIG. 8. Each of the limit members 4 includes abutment end surface 6 abutting against an inner bottom wall of the limit groove 2, second end surface 7 abutting against the first end surface 5, third end surface 8 and fourth end surface 9 that respectively abut against two inner sidewalls of the limit groove 2, and fifth end surface 10 connected to the connecting piece. The third end surface 8 and the fourth end surface 9 are respectively located at two sides of the abutment end surface 6. The third end surface 8 is connected to the second end surface 7. The fourth end surface 9 is connected to the fifth end surface 10. The fifth end surface 10 is located between an inner wall of the second hole and the outer wall of the connector 1. When the limit member 4 is mounted, the limit member 4 is placed into the limit groove 2, and the abutment end surface 6 of the limit member 4 (an internal arc-shaped surface of the limit member 4) abuts against the inner bottom wall of the limit groove 2, as shown by FIGS. 9B-9D. In this case, the third end surface 8 abuts against an inner sidewall of one side of the limit groove 2. The fourth end surface 9 abuts against an inner sidewall of another side of the limit groove 2. The fifth end surface 10 is located outside the limit groove 2, and faces toward the opening of the connector 1, so as to facilitate subsequent assembly and disassembly of the connecting piece. According to use and design requirements, the fifth end surface 10 and the fourth end surface 9 may be coplanar, and the fifth end surface 10 may also be located outside the limit groove 2 and extend to the opening of the connector 1, as shown in FIGS. 9A-9D. The fifth end surface 10 and the fourth end surface 9 may be two planes parallel to each other, and may also be two planes forming a non-zero included angle, as shown in FIG. 8. The fourth end surface 9 and the third end surface 8 may be configured to axially limit the position of the limit member 4, preventing the limit member 4 from shaking axially in the limit groove 2. After the limit member 4 is placed into the limit groove 2, all or two adjacent limit members 4 may be connected by the connecting piece through the fifth end surface 10 to form a whole (see details in the first and second implementations of the connecting piece), or the connecting piece may selectively abut against the fifth end surface 10 (see details in the third implementation of the connecting piece), such that the limit assembly neither is dispersed from the connector 1, not falls off. After the limit assembly is mounted, the flange 3 is moved toward the opening of the connector 1, and the first end surface 5 abuts against the second end surface 7, such that the limit assembly can axially limit the position of the flange 3 to prevent the flange 3 from falling off from the connector 1. Because of Rf≥Rx, the flange 3 can be rotated relative to the limit assembly. To reduce the wear and resistance caused by rotation, an outer sidewall of the flange 3 is provided with a third through hole communicated with the second hole. An opening of the third through hole adjacent to the outer sidewall of the flange 3 is provided with nozzle 14. With the nozzle 14, a lubricant can be injected into a space of the limit assembly, such that the flange 3 can be rotated freely relative to the limit assembly and the connector 1. This is convenient to rotate the flange 3 in abutment to adjust a position of a screw hole.

In the first implementation of the connecting piece, the connecting piece includes annular first connecting piece 11. The first connecting piece 11 is axially provided with at least two first through holes. At least one threaded hole is formed in the fifth end surface 10 of each of the limit members 4. A quantity and positions of first through holes are matched with a quantity and positions of threaded holes. The first connecting piece 11 is connected to the fifth end surface 10 through screws. Typically, an outer diameter of the first connecting piece 11 is not greater than the Rf, such that the first connecting piece 11 can be accommodated in a space between the inner wall of the second hole and the outer wall of the connector 1. An end surface of the first connecting piece 11 away from the fifth end surface 10 is axially provided with a plurality of placement grooves. The screws are respectively located in the plurality of placement grooves. Typically, when the outer diameter of the first connecting piece 11 is less than the Rf, a gap is formed between an outer wall of the first connecting piece 11 and the inner wall of the second hole. In this case, the limit assembly can only axially limit movement of the flange 3 in a single direction, that is, it prevents the flange 3 from falling out of the connector 1, but cannot prevent movement of the flange 3 away from the opening of the connector 1 to cause separation of the flange 3 from the limit assembly. Although the present disclosure is not affected by the separation of the flange 3 from the limit assembly in use, in order to axially limit the flange 3 in two directions, the inner wall of the second hole may be provided with an L-shaped snap groove, and the outer wall of the first connecting piece 11 may be provided with a protrusive snap member. During mounting, the snap member of the first connecting piece 11 is inserted into the snap groove, and is moved axially. When the snap member reaches an inflection point of the L-shaped snap groove, the first connecting piece 11 is rotated, such that the snap member and the snap groove are axially snap-fitted for limiting. Then, the first connecting piece 11 is connected to the fifth end surface 10 through the screws, such that the flange 3 can be axially limited in the two directions.

In the second implementation of the connecting piece, the connecting piece includes a plurality of arc-shaped second connecting pieces 12. The second connecting pieces 12 are matched with the limit members 4 in quantity. At least two threaded holes are formed in the fifth end surface 10 of each limit member 4. The threaded holes are respectively located at two ends of each limit member 4. Each of the second connecting pieces 12 is axially provided with at least two second through holes. The second connecting piece 12 is connected to the at least two threaded holes through screws. Two adjacent limit members 4 are connected via the second connecting piece 12. The second connecting piece 12 is mounted at a joint between two limit members 4. The second connecting piece 12 includes one part connected to one end of one limit member 4, and the other part connected to one end of the other limit member 4, as shown in FIG. 5. In this embodiment, compared with the first implementation, there is no need to drill many holes in the limit member 4, which reduces the machining workload of the limit member 4. Since the second connecting piece 12 is only connected to a part of the limit member 4, the arc-shaped second connecting piece 12 can be used as a prefabricated part and a universal part, and can be mass-produced as it eliminates the need for one-to-one component customization required in the first implementation of the connecting piece.

In the third implementation of the connecting piece, the connecting piece includes third connecting piece 13. The third connecting piece 13 is removably connected to the inner wall of the second hole, such that the third connecting piece 13 can be connected to the flange 3 to form a whole. In this embodiment, the fifth end surface 10 serves as an abutting surface for limiting the third connecting piece 13. When the flange 3 moves away from the opening of the connector 1, the third connecting piece 13 is driven to move axially, and an end of the third connecting piece 13 abuts against the fifth end surface 10, thereby axially limiting the position of the flange 3. Typically, the inner wall of the second hole is provided with an internal thread. The third connecting piece 13 is an annular structure with an external thread. The third connecting piece 13 has an inner diameter of not less than the r, provided that it can be sleeved on the connector 1. An outer wall of the third connecting piece 13 is threadedly connected to the inner wall of the second hole. Since the third connecting piece 13 is connected to the flange 3 to form the whole, the limit member 4 is not additionally machined, reducing the machining difficulty of the limit member 4, lowering the production cost, and effectively reducing leakage of the lubricant after the lubricant is injected through the nozzle 14.

In the description of the present disclosure, the terms "central", ''longitudinal'', ''transverse'', ''length'', ''width'', ''thickness'', "upper", "lower", ''front'', ''back'', "left", "right", "vertical", "horizontal", ''top'', ''bottom'', "inner", "outer", ''clockwise'', ''anticlockwise'', ''axial'', ''radial'' and ''circumferential'' etc. are used to indicate orientations shown in the accompanying drawings. It should be noted that these terms are merely intended to facilitate a simple description of the present disclosure, rather than to indicate or imply that the mentioned apparatus or elements must have the specific orientation or be constructed and operated in the specific orientation. Therefore, these terms may not be construed as a limitation to the present disclosure.

In the present disclosure, unless otherwise clearly limited, the terms ''installation'', "interconnection", ''connection'' and "fixation" etc. are intended to be understood in a broad sense. For example, the "connection" may be a fixed connection, a removable connection or an integral connection; may be a mechanical connection, an electrical connection or a communication connection; may be a direct connection or an indirect connection using a medium; and may be a communication or an interaction between two elements, unless otherwise clearly specified and limited. Those of ordinary skill in the art may understand specific meanings of the above terms in the present disclosure based on a specific situation.

The implementation solutions of the present disclosure described above are not limited to the applications listed in the specification and implementations, but are absolutely applicable to various fields suitable for the present disclosure. Therefore, additional modifications can be easily made by those skilled in the art, and without departing from the general concepts defined by the claims and equivalent scopes thereof, the present disclosure is not limited to specific details and legends shown herein.

1. A fracturing hose for a high-pressure oilfield, comprising: a hose and a connector disposed at an end of the hose, wherein the connector is a tubular structure with an outer diameter of r; an outer wall of the connector is provided with a limit groove and a flange; a limit assembly is disposed in the limit groove; the flange is sleeved outside the connector; and the limit assembly is configured to limit a position of the flange.

2. The fracturing hose for the high-pressure oilfield according to claim 1, wherein the limit assembly comprises at least two arc-shaped limit members and a connecting piece; the at least two arc-shaped limit members are located in the limit groove; every two adjacent limit members in the at least two arc-shaped limit members are connected via the connecting piece; and the at least two arc-shaped limit members are configured to limit the position of the flange.

3. The fracturing hose for the high-pressure oilfield according to claim 2, wherein a central hole of the flange comprises a first hole with an inner diameter of R and a second hole with an inner diameter of Rf, wherein the first hole communicates with the second hole, and Rf＞R, R ≥ r; and a junction between the first hole and the second hole forms a first end surface abutting against the at least two arc-shaped limit members.

4. The fracturing hose for the high-pressure oilfield according to claim 3, wherein each of the at least two arc-shaped limit members comprises:
an abutment end surface abutting against an inner bottom wall of the limit groove,
a second end surface abutting against the first end surface,
a third end surface and a fourth end surface that respectively abut against two inner sidewalls of the limit groove, and
a fifth end surface connected to the connecting piece;
wherein the third end surface and the fourth end surface are respectively located at two sides of the abutment end surface; the third end surface is connected to the second end surface; the fourth end surface is connected to the fifth end surface; and the fifth end surface is located between an inner wall of the second hole and the outer wall of the connector.

5. The fracturing hose for the high-pressure oilfield according to claim 4, wherein the connecting piece comprises an annular first connecting piece; the annular first connecting piece is axially provided with at least two first through holes; at least one threaded hole is formed in the fifth end surface of each of the at least two arc-shaped limit members; a quantity and positions of first through holes are matched with a quantity and positions of threaded holes; and the annular first connecting piece is connected to the fifth end surface through screws.

6. The fracturing hose for the high-pressure oilfield according to claim 5, wherein an end surface of the annular first connecting piece away from the fifth end surface is axially provided with a plurality of placement grooves; and the screws are respectively located in the plurality of placement grooves.

7. The fracturing hose for the high-pressure oilfield according to claim 4, wherein the connecting piece comprises a plurality of arc-shaped second connecting pieces; the plurality of arc-shaped second connecting pieces are matched with the at least two arc-shaped limit members in quantity; at least two threaded holes are formed in the fifth end surface of each of the at least two arc-shaped limit members; the at least two threaded holes are respectively located at two ends of each of the at least two arc-shaped limit members; each of the plurality of arc-shaped second connecting pieces is axially provided with at least two second through holes; each of the plurality of arc-shaped second connecting pieces is connected to the at least two threaded holes through screws; and every two adjacent limit members in the at least two arc-shaped limit members are connected via each of the plurality of arc-shaped second connecting pieces.

8. The fracturing hose for the high-pressure oilfield according to claim 4, wherein the connecting piece comprises a third connecting piece; the third connecting piece is removably connected to the inner wall of the second hole; and the fifth end surface selectively abuts against an end of the third connecting piece.

9. The fracturing hose for the high-pressure oilfield according to claim 8, wherein the inner wall of the second hole is provided with an internal thread; the third connecting piece is an annular structure with an external thread; and an outer wall of the third connecting piece is threadedly connected to the inner wall of the second hole.

10. The fracturing hose for the high-pressure oilfield according to claim 3, wherein an outer sidewall of the flange is provided with a third through hole communicated with the second hole; and an opening of the third through hole adjacent to the outer sidewall of the flange is provided with a nozzle.
